(19) United States
(12) Patent Application Publication
(10) Pub. No.: US 2006/0294380 A1
(43) Pub. Date: Dec. 28, 2006

(54) Mechanism to evaluate a token enabled computer system

(76) Inventor: Selim Aissi, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/168,204

(22) Filed: Jun. 28, 2005

(51) Int. Cl. H04L 9/00

(52) U.S. Cl. 713/172

(57) ABSTRACT

According to one embodiment, computer system is disclosed. The computer system includes a central processing unit (CPU) to operate a trusted environment, a chipset having protected registers that are writable by commands initiated by trusted microcode in the CPU, a fixed token coupled to the chipset to protect data related to creating and maintaining the trusted operating environment and a portable token coupled to the chipset to verify the integrity of the trusted operating environment.

### FIELD OF THE INVENTION

The present invention relates to computer systems; more particularly, the present invention relates to computer systems that may operate in a trusted or secured environment.

### BACKGROUND

The increasing number of financial and personal transactions being performed on local or remote microcomputers has given impetus for the establishment of “trusted” or “secured” microprocessor environments. The problem these environments try to solve is that of loss of privacy, or data being corrupted or abused. Users do not want their private data made public. They also do not want their data altered or used in inappropriate transactions. Examples of these include unintentional release of medical records or electronic theft of funds from an on-line bank or other depository. Similarly, content providers seek to protect digital content (for example, music, other audio, video, or other types of data in general) from being copied without authorization.

Trusted environments include a fixed physical token (e.g., Trusted Platform Module or TPM) for root-of-trust as well as hardware-based cryptographic services to the operating system and applications running in trusted execution partitions. However, with the expected ubiquity of such trusted platforms, there currently is no mechanism that would allow the user/owner of a platform to verify that the platform is actually trusted.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates one embodiment of a central processing unit;

FIG. 3 is a diagram of one embodiment of a trusted or secured software environment;

FIG. 4 is a flow diagram of one embodiment for performing an evaluation of a fixed token; and

FIG. 5 is an event diagram of one embodiment for performing an evaluation of a fixed token.

### DETAILED DESCRIPTION

A mechanism to evaluate a physical (or fixed) token in a trusted computer system is described. According to one embodiment, a fixed token is identified. Subsequently, a user is authenticated and the trustworthiness of the computer system is verified. Finally, an indication is provided as to whether the computer system succeeded or failed the evaluation.

In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

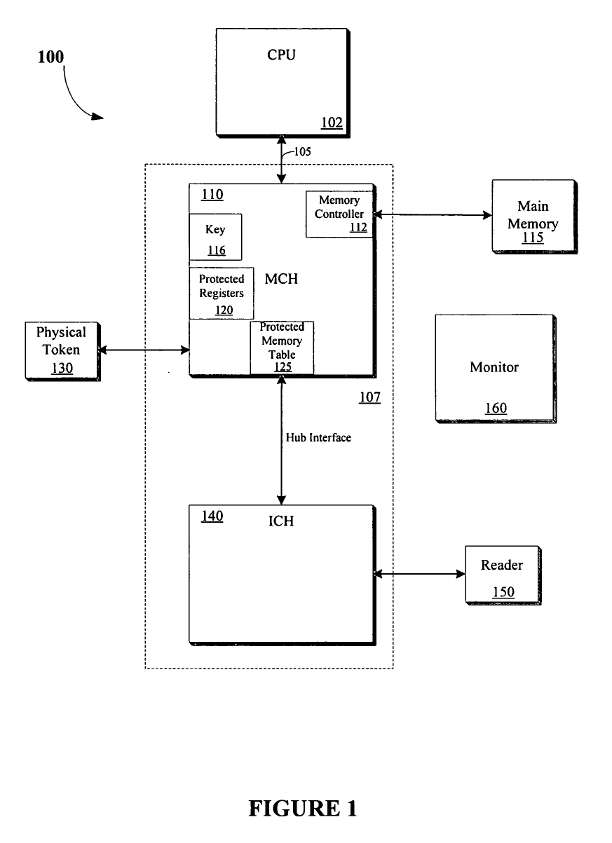

FIG. 1 is a block diagram of one embodiment of a computer system 100. Computer system 100 includes a central processing unit (CPU) 102 coupled to bus 105. In one embodiment, CPU 102 is a processor in the Pentium® family of processors including the Pentium® II processor family, Pentium® III processors, and Pentium® IV processors available from Intel Corporation of Santa Clara, Calif. Alternatively, other CPUs may be used.

According to one embodiment, CPU 102 includes circuits or logic elements to support secure or trusted operations. For example, CPU 102 may include secure enter (SENTER) logic, not shown, to support the execution of special SENTER instructions that may initiate trusted operations, which may curtail the ability of potentially hostile untrusted code to access secure resources within computer system 100.

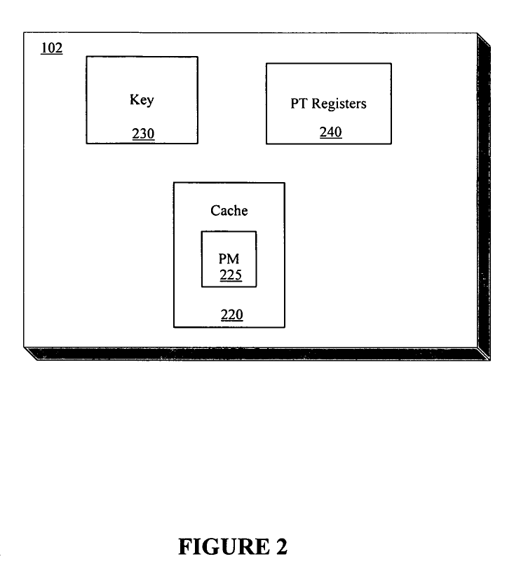

Additionally, CPU 102 may include secure memory to support secure operations. FIG. 2 is a block diagram illustrating one embodiment of CPU 102. CPU 102 includes cache memory (cache) 220, embedded key 230, and page table (PT) registers 240. All or part of cache 220 may include, or be convertible to, private memory (PM) 225. According to one embodiment, private memory 225 is a memory with sufficient protections to prevent access to it by any unauthorized device (e.g., any device other than the associated CPU 102) while activated as a private memory.

In the illustrated embodiment, cache 220 may have various features to permit its selective isolation as a private memory. In another embodiment not shown, private memory 225 may be external to and separate from cache memory 220, but still associated with CPU 102. Key 230 may be an embedded key to be used for encryption, decryption, and/or validation of various blocks of data and/or code. PT registers 240 may be a table in the form of registers to identify memory pages that are to be accessible only by protected code, and which memory pages are not to be protected.

Referring back to FIG. 1, a chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types. Additional devices may also be coupled to bus 105, such as multiple CPUs and/or multiple system memories.

Memory 115 may include a protected memory table to define which memory blocks (where a memory block is a range of contiguously addressable memory locations) in memory 115 are to be inaccessible to direct memory access (DMA) transfers. Since all accesses to memory 115 go through MCH 110, MCH 110 may check the protected memory table before permitting any DMA transfer to take place. In a particular embodiment, MCH 110 may use caching techniques to reduce the number of necessary accesses to protected memory table 320.

According to one embodiment, MCH 110 includes key 116 to be used in various encryption, decryption and/or validation processes, protected registers 120 and protected memory table 125. In one embodiment, the protected memory table 125 is implemented in MCH 110 as protected memory table 125 and the protected memory table in memory 115 may be eliminated.

In another embodiment, protected memory table 125 is implemented as the protected memory table in memory 115 as previously described and protected memory table 125 may be eliminated. The protected memory table may also be implemented in other ways not shown. Regardless of physical location, the purpose and basic operation of the protected memory table may be substantially as described.

In one embodiment, protected registers 120 are registers that are writable by commands that may only be initiated by trusted microcode in CPU 102. Protected microcode is microcode whose execution may be initiated by authorized instruction(s) and/or by hardware that is not controllable by unauthorized devices.

In one embodiment, protected registers 120 include a register to enable or disable the use of the protected memory table. Protected registers 120 may also include a writable register identifying the location of the protected memory table so that the location does not have to be hardwired into MCH 110.

MCH 110 is coupled to an input/output control hub (ICH) 140 via a hub interface. ICH 140 provides an interface to input/output (I/O) devices within computer system 100. ICH 140 may support standard I/O operations on I/O busses such as peripheral component interconnect (PCI), accelerated graphics port (AGP), universal serial bus (USB), low pin count (LPC) bus, or any other kind of I/O bus (not shown). According to one embodiment, ICH is coupled to a reader 150. In one embodiment reader 150 is a smartcard reader that is implemented to interface with (or read) smartcards having a portable token stored thereon. The implementation of the portable token will be described in detail below.

An interface may be used to connect chipset 107 with a physical token 130. Physical token 130 may be a circuit to protect data related to creating and maintaining a protected operating environment. In a particular embodiment, physical token 130 includes a key (not shown), which may be an embedded key to be used for specific encryption, decryption and/or validation processes.

Physical token 130 may also include storage space to be used to hold a digest value and other information to be used in the protected operating environment. In one embodiment the storage space in physical token 130 may include non-volatile memory (e.g., flash memory) to retain its contents in the event of power loss to the physical token.

A secure Virtual Machine Monitor 130 module may be stored on a system disk or other mass storage, and moved or copied to other locations as necessary. In one embodiment, prior to beginning a secure launch process monitor 160 may be moved or copied to one or more memory pages in memory 115. Following a secure enter process, a virtual machine environment may be created in which monitor 160 may operate as the most privileged code within the system, and may be used to permit or deny direct access to certain system resources by the operating system or applications within the created virtual machines.

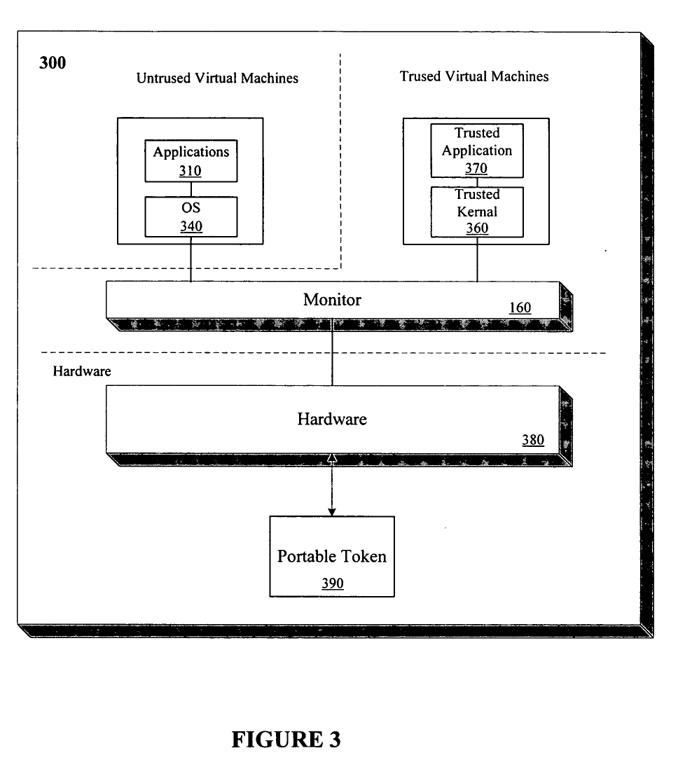

Once execution control is transferred to monitor 160, computer system 100 enters a trusted or secured software environment (or platform). FIG. 3 illustrates one embodiment of a trusted or secured platform 300. In the FIG. 3 embodiment, trusted and untrusted software may be loaded simultaneously and may execute simultaneously on a single computer system. Monitor 160 selectively permits or prevents direct access to hardware resources 390 from one or more untrusted operating systems 340 and untrusted applications 310.

In this context, “untrusted” does not necessarily mean that the operating system or applications are deliberately misbehaving, but that the size and variety of interacting code makes it impractical to reliably assert that the software is behaving as desired, and that there are no viruses or other foreign code interfering with its execution. In a typical embodiment, the untrusted code might include the normal operating system and applications found on today's personal computers.

Monitor 160 also selectively permits or prevents direct access to hardware resources 380 from one or more trusted or secure kernels 360 and one or more trusted applications 370. Such a trusted or secure kernel 360 and trusted applications 370 may be limited in size and functionality to aid in the ability to perform trust analysis upon it. The trusted application 370 may be any software code, program, routine, or set of routines which is executable in a secure environment. Thus, the trusted application 370 may be a variety of applications, or code sequences, or may be a relatively small application such as a Java applet.

Instructions or operations normally performed by operating system 340 or kernel 360 that could alter system resource protections or privileges may be trapped by monitor 160, and selectively permitted, partially permitted, or rejected. As an example, in a typical embodiment, instructions that change the CPU 102 page table that would normally be performed by operating system 340 or kernel 360 would instead be trapped by monitor 160, which would ensure that the request was not attempting to change page privileges outside the domain of its virtual machine.

Also shown in FIG. 3, is a portable token 390. In one embodiment, portable token 390 is a credential token incorporated within a smart card that may be inserted into smart card reader 150 in order to enable a user to verify whether computer system 100 is a trusted system. In a further embodiment, portable token 390 is provided by an information technology (IT) department affiliated with an entity that supplied computer system 100 to a user.

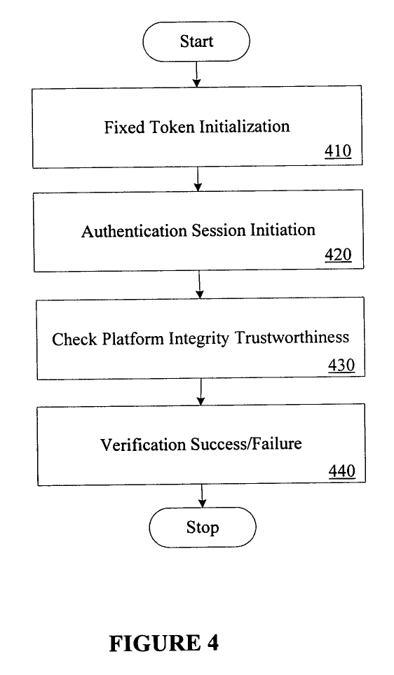

FIG. 4 is a flow diagram of one embodiment for implementing portable token 390 to perform an evaluation of a fixed token 130. At processing block 410, fixed token identification process occurs. This process involves portable token 390 checking the authenticity of fixed token 130 by identifying fixed token 130.

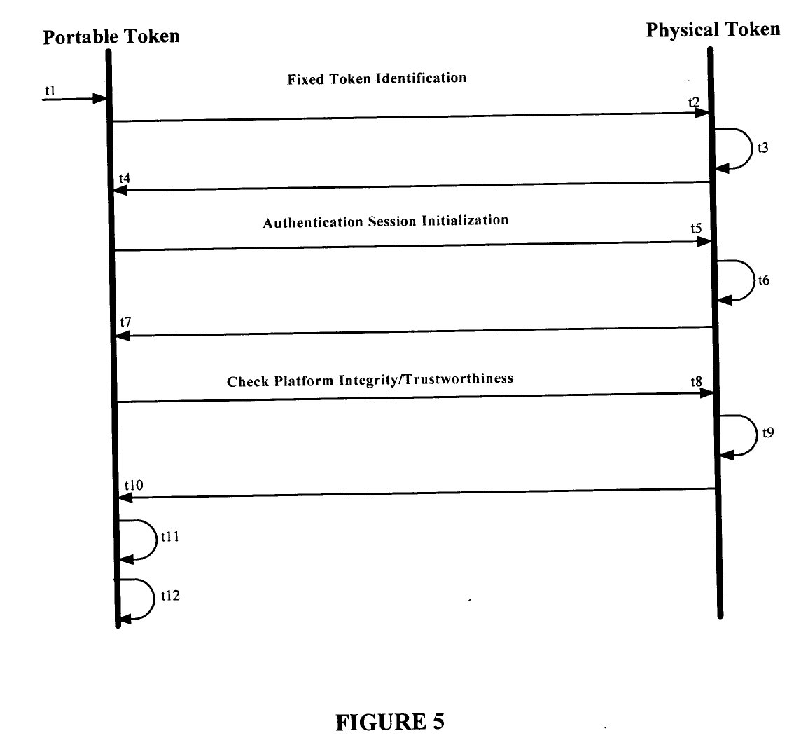

In one embodiment, this identification can be based on a shared secret that an IT administrator provisions in both portable token 390 and fixed token 130. In another embodiment, identification can also be achieved by portable token 390 having a public key of fixed token 130. FIG. 5 is an event diagram illustrating a more detailed sequence for performing an evaluation of a fixed token.

Referring to FIG. 5, the fixed token identification process is carried out in times t1-t4. First, a user inserts portable token 390 into computer system 100 via smartcard reader 150, at t1. At t2, it is determined whether fixed token 130 is authentic. At t3, fixed token 130 authenticity is verified. At t4, it is determined that fixed token 130 is authentic.

Referring back to FIG. 4, an authentication session is initialized at processing block 420. Upon successful identification of fixed token 130 as a valid token, portable token 390 initiates an authentication session with fixed token 130. A pass-phrase may be used for this authentication. According to one embodiment, such a pass-phrase is pre-stored on portable token 390.

Referring back to FIG. 5, the authentication session is performed at times t5-t7, where the session is initiated at t5, a user authentication is checked at t6 and the user is authenticated at t7. If authentication is successful, portable token 390 checks the trustworthiness of computer system 100 using defined integrity measures of the state of computer system 100, processing block 430 (FIG. 4).

Based on the computer system 100 integrity measurements that portable token 390 includes, token 390 will judge the trustworthiness of the platform. In one embodiment, portable token 390 will compare specific PCR values to the values that are stored in its tamperproof integrity container.

Referring back to FIG. 5, the integrity/trustworthiness process is executed in times t8-t10. At time t8, token 390 checks the trustworthiness of system 100. At t2, integrity measurements are retrieved at t9 and forwarded to token 390 at t10. Referring back to FIG. 4, portable token 390 may display success or failure of the computer system 100 challenge session, processing block 440. This process is illustrated in FIG. 5 at times t11 and t12, where portable token 390 verifies the integrity measurements and indicates whether the verification has been completed and whether it is successful. In one embodiment, portable token 390 includes a display to indicate the results of the verification. The display may be an LED or a small LCD screen.

The above-described mechanism enables a smartcard (e.g., portable token) and a fixed token (such as a TPM) to complement one another in order to enhance trustworthiness of a trusted system. The cooperation between the portable token and the fixed token that allows a user/owner of the platform to check the integrity and trustworthiness of that platform before using the platform.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer system comprising:
a central processing unit (CPU) to operate a trusted environment;
a chipset having protected registers that are writable by commands initiated by trusted microcode in the CPU;
a fixed token, coupled to the chipset, to protect data related to creating and maintaining the trusted operating environment; and
a portable token, coupled to the chipset, to verify the integrity of the trusted operating environment.

2. The computer system of claim 1 wherein the portable token verifies the authenticity of the fixed token.

3. The computer system of claim 2 wherein the portable token verifies the authenticity of a user of the trusted environment.

4. The computer system of claim 3 wherein the portable token verifies the integrity of the trusted operating environment by retrieving integrity measurements from the trusted operating environment.

5. The computer system of claim 1 wherein the portable token is a smartcard.

6. The computer system of claim 5 further comprising an interface coupled to the chipset to read the smartcard.

7. The computer system of claim 5 wherein the portable token comprises a display to indicate results of the integrity verification.

8. A method comprising:
a portable token identifying a fixed token within a trusted operating environment;
verifying the authenticity of a user of the trusted operating environment; and
verifying the integrity of the trusted operating environment.

9. The method of claim 8 wherein identifying the fixed token comprises verifying the authenticity of the fixed token.

10. The method of claim 8 wherein verifying the integrity of the trusted operating environment comprises comparing a first set of values stored at the portable token with a second set of values received from the fixed token.

11. The method of claim 10 further comprising displaying an indication indicating if the trusted operating environment has been verified.

12. A smartcard comprising a portable token to verify the integrity of a trusted computer system platform.

13. The smartcard of claim 12 wherein the portable token verifies the authenticity of the fixed token.

14. The smartcard of claim 13 wherein the portable token verifies the authenticity of a user of the trusted operating environment.

15. The smartcard of claim 14 wherein the portable token verifies the integrity of the trusted operating environment by retrieving integrity measurements from the trusted operating environment.

16. The smartcard of claim 12 further comprising a display to indicate results of the integrity verification.

17. An article of manufacture including one or more computer readable media that embody a program of instructions, wherein the program of instructions, when executed by a processing unit, causes:
a portable token to identify a fixed token within a trusted operating environment;
the portable token to verify the authenticity of a user of the trusted operating environment; and
the portable token to verify the integrity of the trusted operating environment.

18. The article of manufacture of claim 17 wherein identifying the fixed token comprises verifying the authenticity of the fixed token.

19. The article of manufacture of claim 17 wherein verifying the integrity of the trusted operating environment comprises comparing a first set of values stored at the portable token with a second set of values received from the fixed token.

20. The article of manufacture of claim 17 wherein the program of instructions, when executed by a processing unit, further causes the portable token to display an indication indicating if the trusted operating environment has been verified.
